(19) United States
(12) Patent Application Publication
(10) Pub. No.: US 2008/0163275 A1
(43) Pub. Date: Jul. 3, 2008

(54) OPTICAL DISC APPARATUS

(75) Inventor: Naoki Eguchi, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/960,188

(22) Filed: Dec. 19, 2007

(30) Foreign Application Priority Data
Dec. 27, 2006 (JP) 2006-353296

(51) Int. Cl. G11B 17/04

(52) U.S. Cl. 720/623

(57) ABSTRACT

According to one embodiment, an optical disc apparatus includes no engagement members that couple the mechanical base chassis to the mechanism provided in the main unit and related to the process of clamping the sub-chassis, i.e., chassis of the pickup-head (PUH) traverse mechanism. It is possible to suppress the minute vibration resulting from the interference of mechanical components with the PUH traverse mechanism, which occurs due to background vibration or the internal vibration. This increases the vibration resistance.

### CROSS-REFERENCE TO RELATED APPLICATIONS

This application is based upon and claims the benefit of priority from Japanese Patent Application No. 2006-353296, filed Dec. 27, 2006, the entire contents of which are incorporated herein by reference.

### BACKGROUND

1. Field

One embodiment of the invention relates to an optical disc apparatus that can read data from a disc recording medium, such as an optical disc, and record data in the optical disc, and to a chassis structure for use in optical disc apparatuses.

2. Description of the Related Art

Optical disc apparatuses (optical disc drives) have long been in practical use, each configured to apply a laser beam to an optical disc, thereby reproducing data from the optical disc and recording data on the optical disc.

The optical disc drive includes an optical pickup (optical head) device, a loading mechanism, a disc motor, and a control circuit. The optical pickup is moved radially across the data-recording surface of an optical disc. While being so moved, the optical pickup can read data from and write data to the optical disc. The loading mechanism is configured to load an optical disc to a prescribed position (in the optical disc drive) and to eject the disc reliably from the optical disc drive. The disc motor rotates the optical disc. The control circuit performs miscellaneous control to record data on and reproduce data from the optical disc.

Today, the optical disc apparatus surpasses the household-use video tape recorder in terms of sales. In addition, optical discs are taking place of the tape, as recording media for use in video cameras. In view of this, most personal computers, audio-video systems for use in car, and portable players, each having an optical disc apparatus, can reproduce data from optical discs anytime and anywhere.

However, personal computers, portable players, and audio-video systems for use in cars must have high vibration resistance and must be a small.

Japanese Patent No. 3149052 discloses a frame for use in flexible disc drives, which comprises a frame member, a thin-wall part, a bearing-holding member. The frame member has two sidewalls. The thin-wall part integrally formed with the bottom wall of the frame by means of pressing and configured to hold a spindle motor. The thin-wall part has a plurality of holes have eliminated the strain generated during the pressing. The bearing-holding member is provided on the center part of the thin-wall part and has a hole through which the shaft of the spindle motor may pass.

Japanese Patent Application Publication (KOKAI) No. 8-88995 discloses a flexible disc drive comprising a spindle motor, a magnetic head, a frame, and a carriage. The spindle motor is a sensor-less driven type and can drive a magnetic disc. The magnetic head may face a magnetic disc. The frame holds the carriage. The carriage can move in the radial direction of the magnetic disc. The frame has a motor base having a hole in the center part. In the hole, the bearing of the spindle motor is held by means of caulking.

In the frame for use in flexible disc drives, disclosed in Japanese Patent No. 3149052, and in the flexible disc drive disclosed in the Japanese Patent Application 8-88995, too, a part of the motor is integrally formed with the base of the disc drive.

Forming a part of the motor integrally with the base can indeed reduce the thickness or weight of the disc drive. However, this may cause the base to vibrate when the motor rotates the disc and may cause the disc drive to receive background vibration readily. If the base vibrates as the motor rotates the disc, errors may be made in reproducing data from the disc or recording data in the disc. Further, if the vibration is relatively prominent, the disc may be damaged, possibly making it difficult to reproduce or record data from or in the disc, either partly or entirely.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an optical disc apparatus according to an embodiment of the invention;

FIG. 2 is an exemplary diagram of the optical disc apparatus shown in FIG. 1, with some components removed and some components added, explaining how an optical disc is inserted into the apparatus;

FIG. 3 is an exemplary diagram of the optical disc apparatus shown in FIG. 2, depicting the disc motor removed from the chassis;

FIG. 4 is an exemplary diagram of the optical disc apparatus shown in FIGS. 1 and 2, explaining how the disc motor is moved up and down as the clamp ring is rotated;

FIG. 5 is an exemplary diagram of the optical disc apparatus shown in FIG. 2, explaining some components that rotate the disc motor;

FIGS. 6A and 6B are exemplary diagrams of the optical disc apparatus shown in FIGS. 2 to 4 explaining how the disc motor is rotated to a standby position to achieving the insertion or ejection of an optical disc, and how the turntable of the disc motor catches an optical disc;

FIGS. 7A to 7C are exemplary diagrams of the optical disc apparatus shown in FIGS. 2 to 4, explaining how the disc motor rotates as it is moved up and down (while remaining at the normal position);

FIGS. 8A to 8C are exemplary diagrams of the optical disc apparatus shown in FIGS. 2 to 4, explaining how the disc motor rotates as it is moved up and down (while rotating);

FIGS. 9A to 9C are exemplary diagrams of the optical disc apparatus shown in FIGS. 2 to 4, explaining how the disc motor rotates as it is moved up and down (while the optical disc is being played black);

FIGS. 10A and 10B are exemplary diagrams of the optical disc apparatus shown in FIG. 1, depicting the mechanical base chassis as viewed from above and from below;

FIG. 10C is an exemplary diagram of the optical disc apparatus shown in FIG. 4 and is a sectional view of a part of the mechanical base chassis as viewed from below;

FIGS. 11A and 11B are exemplary diagrams of the optical disc apparatus shown in FIG. 1, each explaining in detail how a 12-cm optical disc is inserted into the optical disc apparatus;

FIGS. 12A and 12B are exemplary diagrams of the optical disc apparatus shown in FIG. 1, each explaining in detail how an 8-cm optical disc is inserted into the optical disc apparatus; and

FIG. 13 is an exemplary diagram of the optical disc apparatus shown in FIG. 1, depicting an optical disc inserted in the optical disc apparatus and remaining in a rotatable state (because the loading arm and the disc holding lever stay at the standby position.)

### DETAILED DESCRIPTION

Various embodiments according to the invention will be described hereinafter with reference to the accompanying drawings. In general, according to one embodiment of the invention, an optical disc apparatus comprising: a disc motor which has a turntable and rotates a recording medium held by the turntable, at a prescribed seed in a direction parallel to a surface of the recording medium; a main chassis which serves as a bottom surface of the disc motor and holds the disc motor; a pickup head which is configured to read data from the recording medium rotated by the disc motor and to record data in the recording medium; a sub-chassis which supports the pickup head, enabling the pickup head to move in a radial direction of the recording medium; a sub-chassis holding region which is a prescribed region provided on the main chassis and arranged around the disc motor and which supports the sub-chassis; and at least three slits which are arranged, surrounding the sub-chassis holding region, and which substantially separate the main chassis from the sub-chassis.

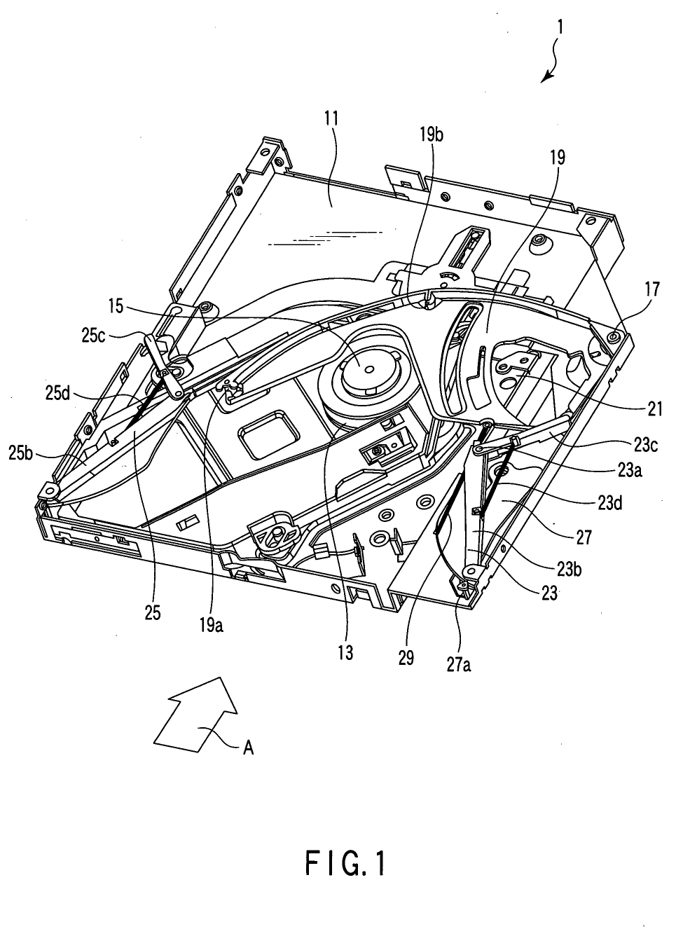

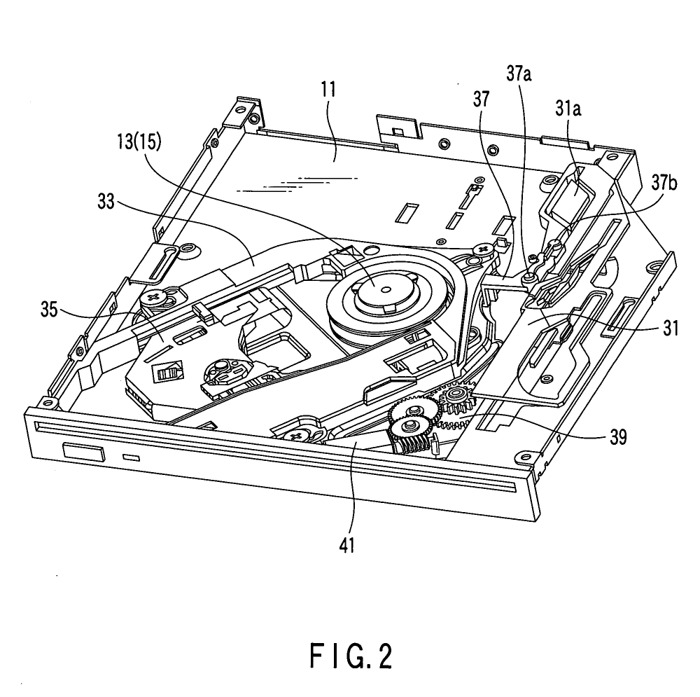

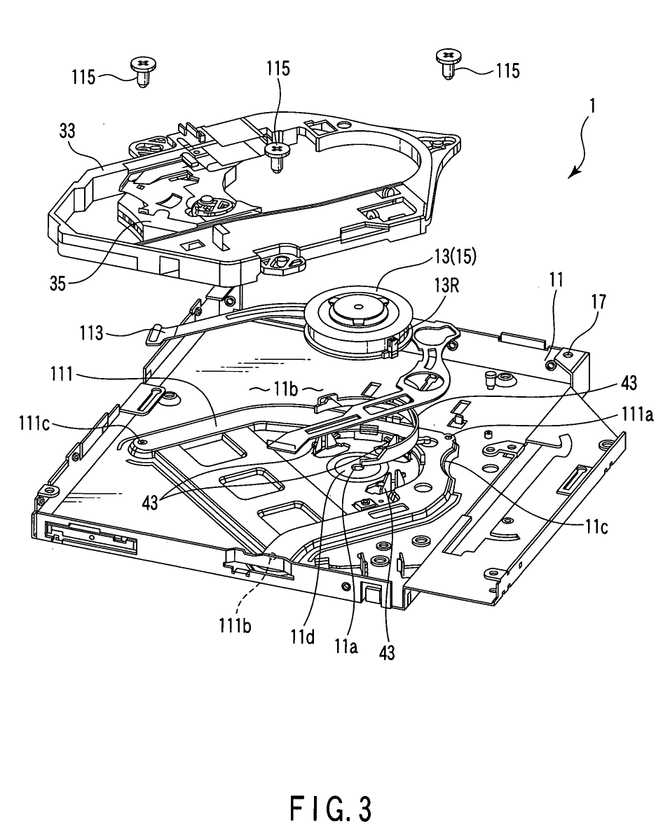

FIGS. 1 to 3 show an example of an optical disc apparatus according to an embodiment of the invention. The optical disc apparatus shown in FIGS. 1 to 3 is a so-called slot-in type, in which an optical disc is inserted in it so that data may be recorded in and reproduced from, the optical disc. The optical disc apparatus is designed for use in, for example, portable personal computers (notebook PCs). FIG. 1 shows the optical disc apparatus, with some parts of the housing having been removed. FIG. 2 shows the optical disc apparatus, with some components having been removed and some components added, and explains how an optical disc is inserted into the optical disc apparatus. FIG. 3 shows the optical disc apparatus shown in FIG. 2, depicting the disc motor removed.

The optical disc apparatus 1 shown in FIGS. 1 to 3 has a bottom cover, i.e., mechanical base chassis 11, and a disc motor 13. The disc motor 13 is mounted on the mechanical base chassis 11, almost at the center of the chassis 11. A turntable 15 is secured to the shaft of the disc motor 13 (not designated by any reference number), to hold an optical disc. The mechanical base chassis 11 is made of a rolled metal plate that is relatively thin.

In the vicinity of the disc motor 13 with which the turntable 15 is integrally formed, a loading arm 19 is provided, which can rotate around an axis defined at a prescribed position on the mechanical base chassis 11.

The loading arm 19 has a first positioning projection 19a and a second positioning projection 19b. The first positioning projection 19a is positioned at prescribed distances from the fulcrum 17. It can contact a part of the circumference of an optical disc inserted toward the turntable 15 in the direction of arrow A. The second positioning projection 19b is positioned between the first positioning projection 19a and the fulcrum 17. The first positioning projection 19a is positioned and shaped to contact a part of the circumference of an optical disc before the recording surface of the optical disc contacts the turntable 15, regardless of the diameter of the optical disc being inserted in the direction of arrow A. The second positioning projection 19b is positioned and shaped to contact the circumference of an optical disc when its center hole substantially aligns with the center of the turntable 15, regardless of the diameter of the optical disc being inserted in the direction of arrow A.

A first disc guide 23 and a second disc guide 25 are provided on two opposing edges of the mechanical base chassis 11, respectively. (In other words, the first disc guide 23 and the second disc guide 25 are located on the right and left of the turn table 15, respectively, as viewed in the direction of arrow A.) The first disc guide 23 and the second disc guide 25 cooperate with the loading arm 19 to support an optical disc being inserted in the direction of arrow A and to guide the optical disc to the loading arm 19. The first and second disc guides 23 and 25 oppose each other across the turntable 15. Thus, the turntable 15 lies between the guides 23 and 25, as viewed in a direction parallel to the shaft of the disc motor 13 that supports the turn table 15.

In the vicinity of the first disc guide 23, a disc holding lever 27 is provided. The disc holding lever 27 has a disc holding pin 27a that cooperates with the first positioning projection 19a to hold the optical disc (being inserted in the direction of arrow A). The disc holding lever 27 can rotate toward the turntable 15, around a fulcrum 27b provided at a prescribed position on the lever 27. The disc holding lever 27 and the loading arm 19 are biased toward each other by a spring member 29. (That is, the spring member 29 always exerts a force that pulls the disc holding lever 27 and the loading arm 19 toward each other and toward the turntable 15.)

The first disc guide 23 is composed of a fulcrum 23a, a main disc guide 23b, a sub disc guide 23c and a spring member 23d. The fulcrum 23a couples the main disc guide 23b and the sub disc guide 23c. The spring member 23d exerts a force (tension) that pulls the main disc guide 23b and the sub disc guide 23c toward each other. The second disc guide 25 is composed of a fulcrum 25a, a main disc guide 25b, a sub disc guide 25c and a spring member 25d. The fulcrum 25a couples the main disc guide 25b and the sub disc guide 25c. The spring member 25d exerts a force (tension) that pulls the main disc guide 25b and the sub disc guide 25c toward each other.

As shown in FIGS. 2 and 3, a sub-chassis 33 is provided on the mechanical base chassis 11, surrounding the disc motor 13 and extending away from the fulcrum 17.

The sub-chassis 33, which has been made by pressing or drawing, is fastened to the sub-chassis holding region 111 of the mechanical base chassis 11, at three points by using three screws 111a, 111b and 111c and three positioning pins 115. A skew-adjusting member 113, which is made of, for example, copper or phosphorus bronze, is interposed between the sub-chassis 33 and the sub-chassis holding region 111. The sub-chassis 33 supports a pickup head (PUH) 35 that can move toward and away from the disc motor 13.

The disc motor 13 is housed in a motor case. The motor case is composed of a hollow cylinder and two plates closing the hollow cylinder at ends. The turntable 15 is secured to one of these plates. The other plate lies flush with the flat part 11b of the mechanical base chassis 11. In other words, a motor-mounting part 11d, which defines the bottom of the motor case, is provided at a prescribed position on the flat part 11b of the mechanical base chassis 11.

Between the sub-chassis 33 and the fulcrum 17, a clamp lever 37 is provided. The clamp lever 37 can rotate around the shaft of the disc motor 13 by a predetermined angle as a cam slider 31 moves in parallel. The clamp lever 37 can rotate around a clamp-lever fulcrum 37a, too, by a predetermined angle along a clamp-cam groove 31a made in the cam slider 31. The clamp lever 37 has a cam-engagement projection 37b, which is set in engagement with the clamp-cam groove 31a. Hence, the clamp lever 37 is rotated by the predetermined angle as the cam slider 31 moves in parallel.

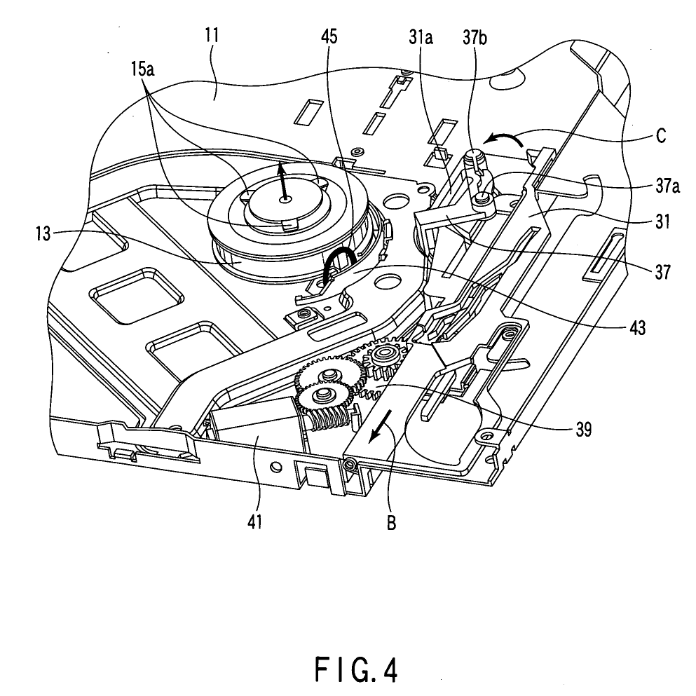

The cam slider 31 can move in parallel in the mechanical base chassis 11 as the forward or inverse rotation of a loading motor 41 is transmitted to the cam slider 31 by a series of gears 39. Assume that the cam slider 31 moves in the direction of arrow B shown in FIG. 4. Then, the clamp lever 37 is rotated in the direction of arrow C. As the clamp lever 37 is rotated, a clamp ring 43 supporting the disc motor 13 is rotated around the shaft of the disc motor 13. As a result, the disc motor 13, which is pushed onto the clamp ring 43 by motor-pushing springs 45, is rotated by a prescribed angle around its shaft as described above.

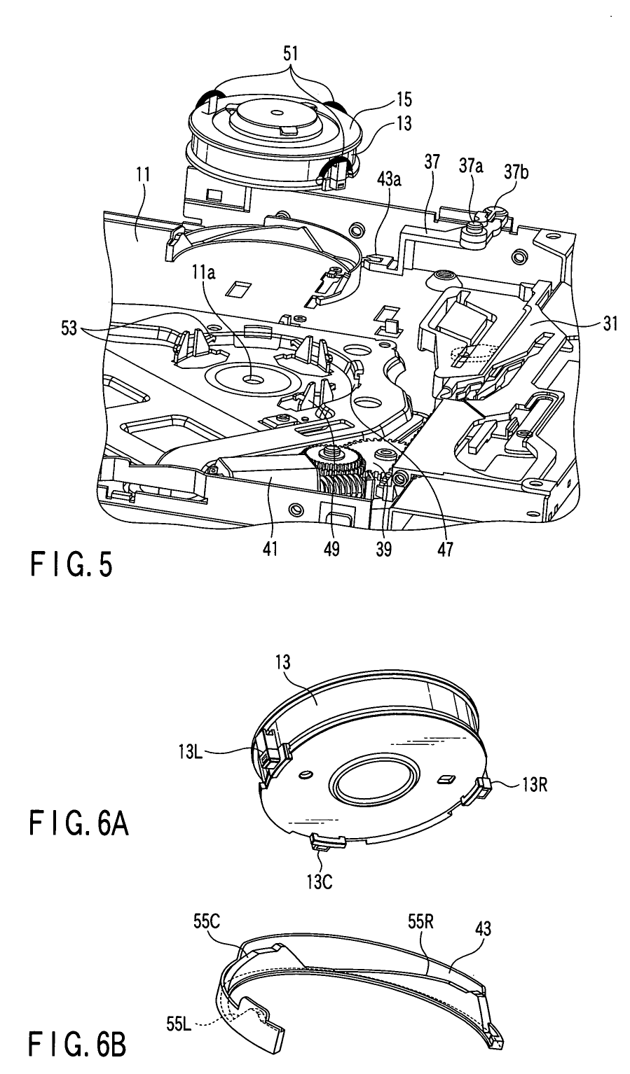

FIG. 5 explains how the disc motor is moved up and down as the clamp ring is rotated as described with reference to FIGS. 2 to 4.

As explained with reference to FIG. 1, the optical disc apparatus 1 is a slot-in type. Therefore, the apparatus 1 performs a loading operation to transport an optical disc into its housing, and an ejecting operation to eject the optical disc from the housing. In most cases, the disc motor remains off the path along which the optical disc moves, until the optical disc is guided to a prescribed position (clamping position), and similarly until the optical disc is ejected from the optical disc apparatus.

To keep the disc motor 13 off the path along which the optical disc moves, the housing (motor case) of the disc motor 13 and the mechanical base chassis 11 of the optical disc apparatus 1 are appropriately designed as will be described below. The disc motor 13 as a whole is thereby rotated around its shaft. The disc motor 13 (particularly, the turntable 15) can therefore approach the mechanical base chassis 11, moving away from the path along which the optical disc moves.

As in FIG. 5 shows, a ring guide wall 47 is provided substantially at the center of the mechanical base chassis 11. The ring guide wall 47 is concentric with the rotation axis 11a of the disc motor 13 (i.e., the axis of the motor shaft) set in place and has a diameter slightly larger than the outer diameter of the motor case housing the disc motor 13.

A plurality of, for example three, lift guides 49 are provided arranged between the ring guide wall 47 and the rotation axis 11a. The lift guides 49 are arranged on a circle having a diameter substantially equal to the diameter of the motor case and are spaced from one another at almost angular intervals of 90° or more. The can restrict the position the disc motor 13 can take and can yet allow the disc motor 13 to move up and down (in a direction parallel to the shaft of the disc motor 13) as will be described below. Each lift guide 49 has a pair of hooks 53 that hold a bias spring 51. The bias springs 51 push the disc motor 13 onto the mechanical base chassis 11 while the lift guides 49 keep holding the disc motor 13.

Cam-abutting projections 13R, 13C and 13L (three projections in this embodiment, as shown in FIG. 6A) are provided on the outer circumferential surface of the hollow cylinder of the motor case and spaced at substantially the same angular intervals as the lift guides 49. The cam-abutting projections 13R, 13C and 13L have the same phase as the lift cams 55R, 55C and 55L (see FIG. 6B) that are arranged between the ring guide wall 47 and the case of the disc motor 13. In the process of assembling the optical disc apparatus 1, the cam-abutting projections 13R, 13C and 13L (FIG. 6A) are positioned at the lift cams 55R, 55C and 55L (FIG. 6B), respectively.

The load the bias springs 53 exert on the hooks 53 always pushes the motor case (disc motor 13) onto the lift cams 55R, 55C and 55L of the clamp ring 55. In this state, the motor case is held on the mechanical base chassis 11. As shown in FIG. 6B, each of the lift cams 55R, 55C and 55L has a standby part (defining the normal position), a slider part continuous to the lowest standby part, a flat part (defining disc-playback position) continuous to the slider part, and a projecting part continuous to the flat part. The normal position is the lowest position the disc motor 13 has. The slider part changes in height in the circumferential direction.

When the clamp ring 55 is rotated around its axis by a prescribed angle, each of the cam-abutting projections 13R, 13C and 13L moves from the standby part to projection part of the corresponding lift cam. As a result, the distance between the motor case (disc motor 13) and the mechanical base chassis 11 is changed. The projecting part of the lift cam 55C is lower than those of the other lift cams 55R and 55L by a preset value. Therefore, the lift guides 49 (three guides) provided on the mechanical base chassis 11 guide the cam-abutting projections 13R, 13C and 13L, respectively. This restricts the position the disc motor 13 has in the plane direction.

The motor-pushing springs 45, which are stretched over the three pairs of hooks 53 formed on the mechanical base chassis 11, push the cam-abutting projections 13R, 13C and 13L onto the lift cams 55R, 55C and 55L. The disc motor 13 is thereby set at a specific position in the height direction. The projection parts of the lift cams 55R, 55C and 55L of the clamp ring 43 serve to lift the disc motor 13 a little higher when the optical disc is clamped (chucked) than when the optical disc is rotated to reproduce signals from it or to record signals in it. Therefore, the projection parts of the lift cams 55R, 55C and 55L are useful to raise the disc motor 13, making it easier to clamp the optical disc.

The clamp ring 43 has a ring-engagement projection 43a on the outer circumferential surface. The ring-engagement projection 43a is set in engagement with an end of the clamp lever 37 that is rotatably supported on the mechanical bas chassis 11. Note that the cam-engagement projection 37b is provided at the other end of the clamp lever 37. The cam-engagement projection 37b is set in the clamp-cam groove 31a made in the cam slider 31, which slides back and forth on the mechanical base chassis 11. Thus, as the cam slider 31 so slides, the clamp lever 37 and the clamp ring 43 are rotated.

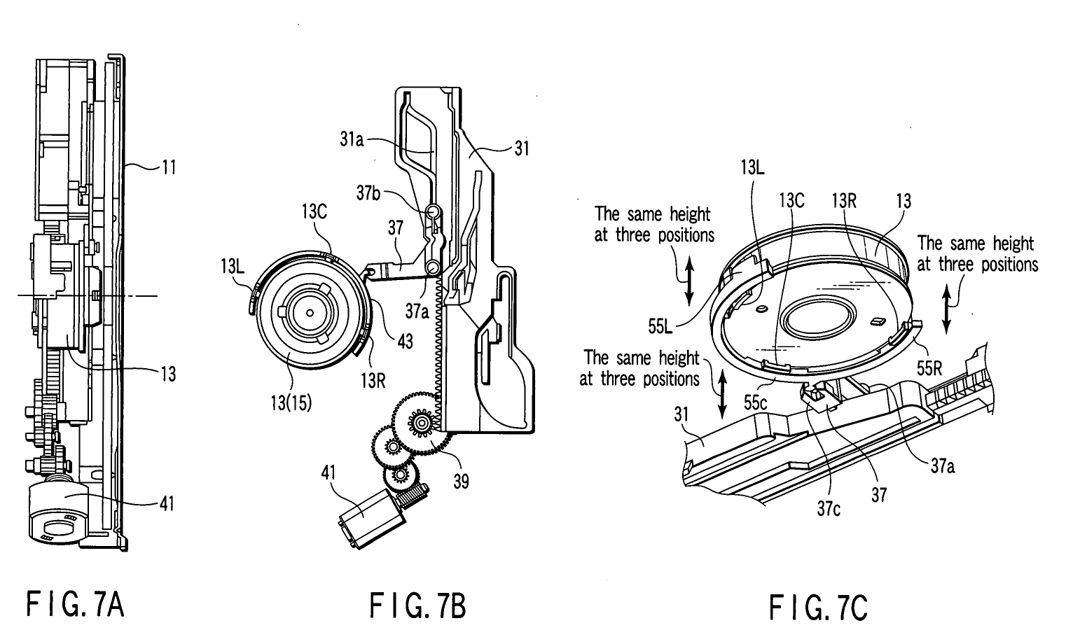

How the disc motor 13 is moved up and down as the cam slider 31 slides will be explained in detail, with reference to FIGS. 7A to 7C, FIGS. 8A to 8C and FIGS. 9A to 9C. Of these figures, FIGS. 7A, 8A and 9A show the positional relation between the disc motor 13 and the mechanical base chassis 11, FIGS. 7B, 8B and 9B show the relation between the parallel motion of the cam slider 31 and the rotations of the clamp ring 43 and clamp lever 37, and FIGS. 7C, 8C and 9C show the positional relation between the disc motor 13 and the lift cams 55R, 55C and 55L of the clamp ring 43.

FIGS. 7A to 7C show the disc motor 13 at the “down” position, or normal position, where the motor 13 remains closest to the mechanical base chassis 11. As seen from FIG. 7B, the line connecting the fulcrum 37a and cam-engagement projection 37b of the clamp lever 37 is almost parallel to the lack-gear section of the cam slider 31. While the disc motor 13 remains at the “down” position, the lift cams 55R, 55C and 55L formed on the clamp ring 43 stay at the lowest position (standby position), and the cam-abutting projections 13R, 13C and 13L of the disc motor 13 stay at the lowest position, substantially close to the mechanical base chassis 11, and are held in horizontal position.

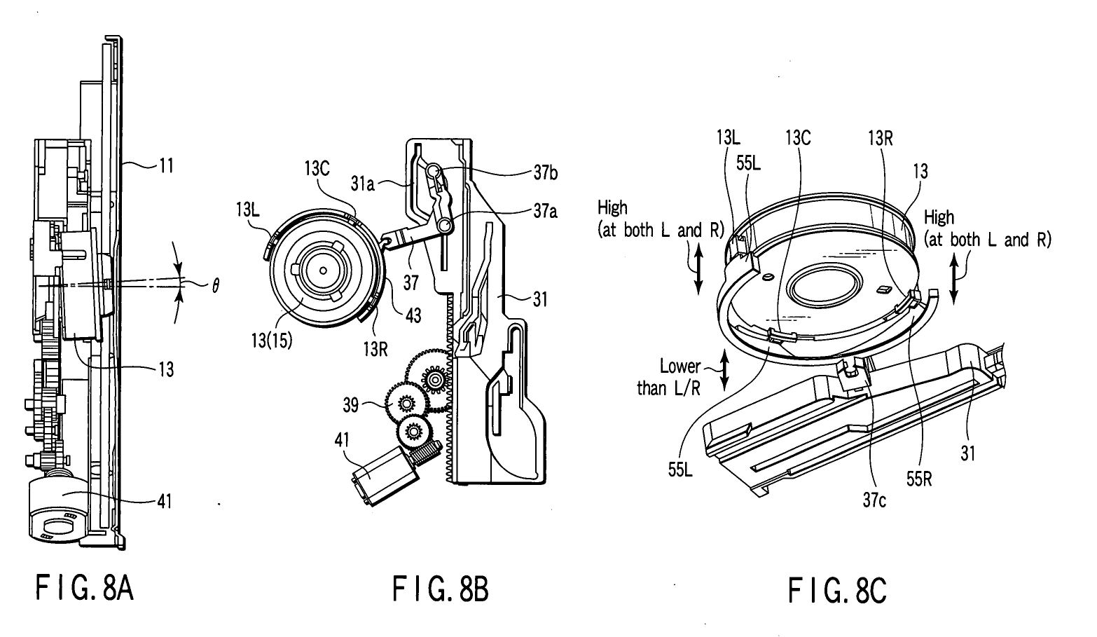

FIGS. 8A to 8C show the lift cams 55R, 55C and 55L of the clamp ring 43, which are set at a sloping section between the “down” position (standby position) and disc-playback position (planar position) of the disc motor 13, or positioned at the slider section for moving the disc motor 13 up and down. As seen from FIG. 8B, the line connecting the fulcrum 37a and cam-engagement projection 37b of the clamp lever 37 is not parallel to the lack-gear section of the cam slider 31. As seen from FIG. 8A, the disc motor 13 inclines by angle θ due to the slider section, to the perpendicular to the center hole 11a made in the mechanical base chassis 11, or to the shaft of the disc motor 13 set at the normal position or disc-playback position. The angle θ of inclination is defined because the projection part of the lift cams 55C has a smaller height than the projection parts of the lift cams 55R and 55L.

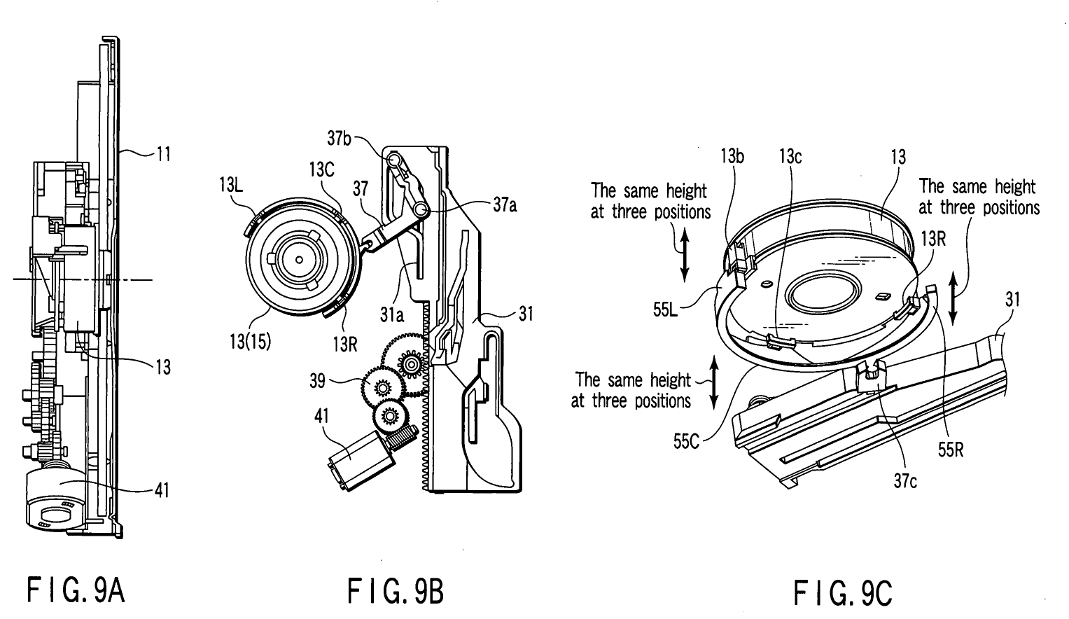

FIGS. 9A to 9C show the disc motor 13 in a completely clamped state. More precisely, they show the cam-abutting projections 13R, 13C and 13L of the disc motor 13, which are set at a planar position (disc-playback position), or at the same height as the lift cams 55R, 55C and 55L of the clamp ring 43. As seen from FIG. 9B, the line connecting the fulcrum 37a and cam-engagement projection 37b of the clamp lever 37 and the lack-gear section of the cam slider 31 defines the largest angle. (The clamp-cam groove 31a made in the cam slider 31 inclines at the largest angle to the lack-gear section.) At this time, the cam-abutting projections 13R, 13C and 13L of the disc motor 13 are pressed on the lift cams 55R, 55C and 55L of the clamp ring 43, respectively, and are therefore held in horizontal position.

Since the cam slider 31 moves in parallel as shown in FIG. 7B, FIG. 8B and FIG. 9B, a 12-cm disc and an 8-cm disc can be easily loaded and positioned in the optical disc apparatus 1, as will be explained later with reference to FIG. 11 to FIG. 13.

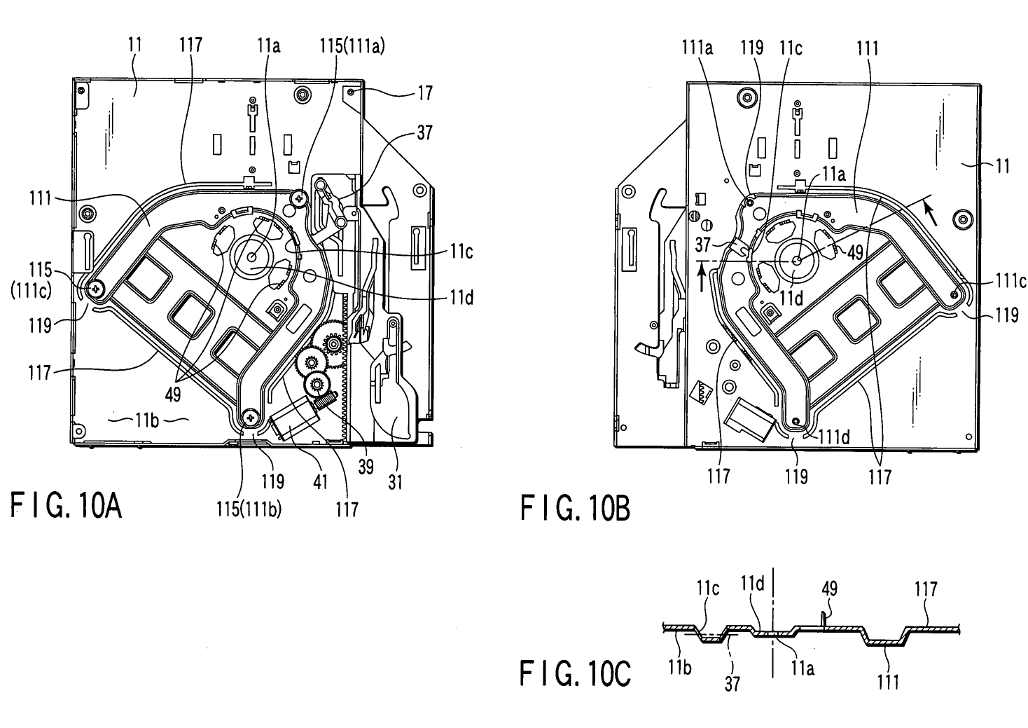

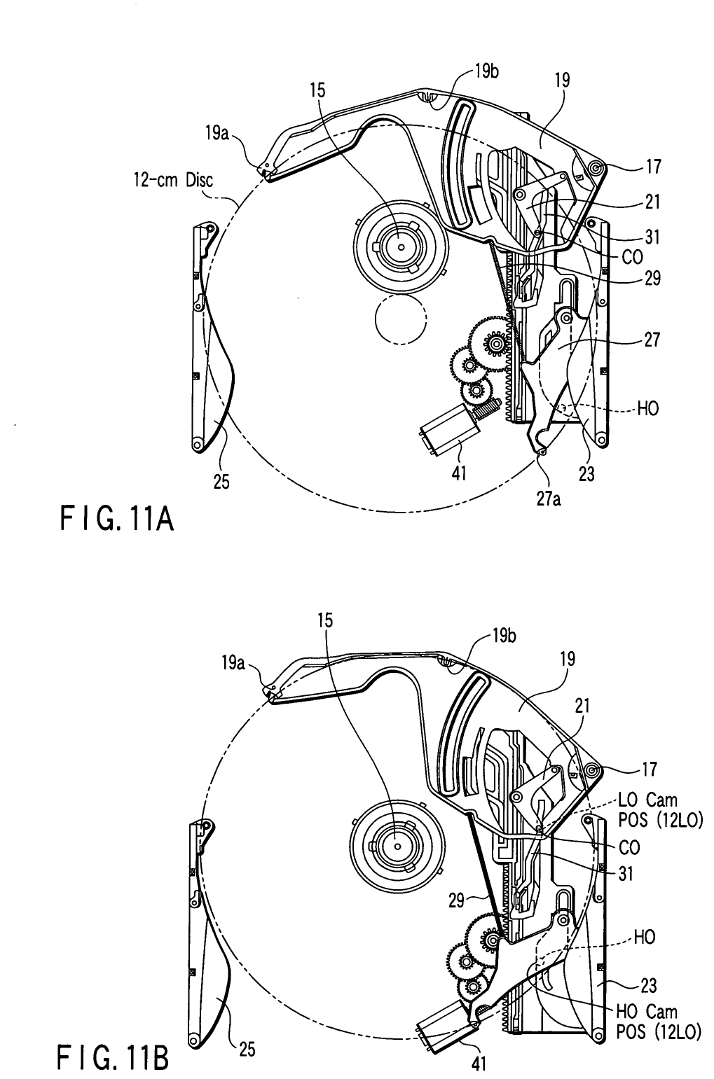

FIGS. 10A and 10B depict the mechanical base chassis 11 as viewed from above and from below. FIG. 10C is a partly sectional view, taken along line X-X shown in FIG. 10B.

As seen from FIGS. 10A to 10C, the sub-chassis holding region 111 of the mechanical base chassis 11 projects toward the flat part 11b, i.e., the main part of the mechanical base chassis 11, in the direction the components of the disc motor 13 are laid one on another. (The sub-chassis holding region 111 has been made by pressing or drawing, thus projecting toward the disc motor 13.)

In the vicinity of that part of the sub-chassis holding region 111, in which the clamp lever 37 is rotated, the clamp lever 37 is inserted between the flat part 11b and sub-chassis holding region 111 of the mechanical base chassis 11. Further, the mechanical base chassis 11 has a cutout 11c in which the clamp lever 37 is inserted and which allows the clamp lever 37 to rotate by an angle falling within a prescribed range. Hence, the clamp lever 37 passes at the cutout 11c, through the gap between the flat part 11b and sub-chassis holding region 111 of the mechanical base chassis 11, when it is rotated around the fulcrum 37a set at the prescribed position on the cam slider 31.

The clamp lever 37 can therefore be connected to the clamp ring 43 on the flat part 11b which is the bottom of the motor case housing the disc motor 13 and located in the sub-chassis holding region 111.

The sub-chassis holding region 111 is separated from the flat part 11b of the mechanical base chassis 11 by strain-preventing slits 117 (three slits as shown in FIGS. 10A and 11B). The strain-preventing slits 117 terminate at connecting parts (non-slit parts) 119 located near the screws 111a, 111b and 111c set in engagement with the positioning pins 115.

The strain-preventing slits 117 are preferably not parallel to one another and have a curved part at one end at least. (The slits 117 are formed, defining the apexes of a triangle, which lie on the outer circumference of the optical disc at a position near the disc motor and at the major and minor axes of the sub-chassis 33. Since the strain-preventing slits 117 are so formed, the mechanical base chassis 11 acquires strength and rigidness against torsion, and the vibration the chassis 11 undergoes while the disc motor 13 being driven can be suppressed. The strain-preventing slits 117 can suppress skew changes caused when the optical disc apparatus 1 including the mechanical base chassis 11 is attached to, for example, a personal computer, a portable player, a audio-video system for use in cars, or the like, or caused by deformation due to disturbance. Further, the strain-preventing slits 117 can impart rigidness to the mechanical base chassis 11 even if the optical disc apparatus 1 receive background vibration.

More specifically, the sub-chassis 33 is rigidly fastened to the sub-chassis holding region 111 integrally formed with the flat part 11b, i.e., the main part of the mechanical base chassis 11, at only the apexes of a triangle, which lie on the outer circumference of the optical disc at a position near the motor holding part and at the major and minor axes. That is, the sub-chassis holding region 111 is connected, at only three parts, to the mechanical base chassis 11. At any other part, the sub-chassis holding region 111 is separated from the mechanical base chassis 11 by the slits (i.e., strain-preventing slits 117).

The sub-chassis 33 can have sufficient rigidness can function as drawn beat that can reinforce various components, though it is thin and made of light metal such as aluminum (Al) or magnesium (Mg).

The mechanical base chassis 11 cannot help but be deformed when the optical disc apparatus 1 is attached to another apparatus or receives external impacts. Nevertheless, the he deformation of the mechanical base chassis 11 can be minimized, thanks to the function of the strain-preventing slits 117 arranged around the sub-chassis 33. (This is because the strain-preventing slits 117 suppress the transmission of strains generated when the apparatus 1 is attached to the other apparatus or the transmission of impacts externally applied.)

Thus, the angle between the optical axis of the objective lens incorporated in the PUH 35 and the recording surface of the optical disc caught by the turntable 25 (disc motor 13) can be easily maintained at high precision. This means that no part is necessary to couple the mechanical base chassis to the mechanism which is provided in the main unit of the optical disc apparatus and which achieves clamping (the optical disc to the turn table) in the PUH transverse mechanisms (sub-chassis), which is indispensable in any slot-in type optical disc apparatus. Thus, it is possible to suppress the minute vibration made because the mechanical components interfere with the PUH traverse mechanism, which occurs due to background vibration or the internal vibration. As a result, the vibration resistance can be increased.

Structure analysis was performed on the mechanical base chassis 11 that has three slits 117 which “correspond to “the apexes of a triangle, which lie on the outer circumference of the optical disc at a position near the motor holding part and at the major and minor axes” or which couples “only the components near the apexes of a triangle.” (The non-slit parts 119 are located near the screws 111a, 111b and 111c.) The results of the analysis are as follows.

In the case where the chassis 11 is made of aluminum alloy and has thickness of 0.6 (equivalent to the thickness of the standard mechanical base chassis), and torsion at the time of attaching is 0.4 mm (rated value for attaching):

(1) The changes in the angle between the optical axis of the PUH and the recording surface of the disc: 2′ or less (rated tolerance: 3′) if the mechanical base chassis 11 has three slits 117.

(2) The changes in the angle: about 20′ (rated tolerance: 3′) if the mechanical base chassis 11 does not have slits 117 at all.

Thus, the optical disc apparatus can be improved in terms of the changes in the angle between the optical axis of the PUH and the recording surface of the disc.

That is, since the mechanical base chassis 11 has three slits 117 which “correspond to “the apexes of a triangle” and has non-slit parts 119 (located near the apexes of a triangle” as shown in FIGS. 10A to 10C, no (independent) mechanical chassis needs to be provided on the mechanical base chassis. Therefore, the optical disc apparatus 1 can be simple in structure, having fewer components than otherwise, and can be thinner and lighter than otherwise.

How a 12-cm disc and an 8-cm disc are loaded and positioned in the optical disc apparatus 1 as the cam slider 31 moves in parallel as shown in FIGS. 7B, 8B and 9B will be explained, with reference to FIGS. 11A and 11B and FIGS. 12A and 12B and FIG. 13.

As shown in FIG. 11A, an optical disc (12-cm disc) is inserted (or pushed) into the optical disc apparatus 1 in the direction of arrow A. The outer circumference of the optical disc eventually contacts, at a given point, the disc holding pin 27a of the disc holding lever 27. The optical disc is then guided toward the loading arm 19 (and toward the turntable 15) and contacts the first positioning projection 19a of the loading arm 19. As described above, the disc holding lever 27 and the loading arm 19 are exerted with a predetermined tension and pulled toward the turntable 15. The optical disc is therefore guided to the turntable 15, while being supported by the disc holding lever 27 and the loading arm 19.

As the optical disc is further pushed in this state, the loading arm 19 rotates around the fulcrum 17, moving away from the turntable 15.

As the optical disc is inserted still further into the optical disc apparatus 1 (or as the loading arm 19 is rotated), the fulcrum 23a of the first disc guide 23 and the fulcrum 25a of the second disc guide 25 are gradually moved outwards, preventing the optical disc from moving in any undesirable manner.

As the optical disc is pushed deeper into the apparatus 1, the fulcrums 23a and 25a of the first and second disc guides 23 and 25, respectively, are moved their outermost positions. As a result, the main disc guide 23b and sub disc guide 23c of the first disc guide 23 extend in a substantially straight line, and the main disc guide 25b and sub disc guide 25c of the second disc guide 25 extend in a substantially straight line as shown in FIG. 8A. Then, the disc holding lever 27 and the loading arm 19 transports the optical disc until the center of the optical disc reaches the turntable 15.

As the disc holding lever 27 and the loading arm 19 are rotated, the optical disc held by the disc holding lever 27 and the loading arm 19 is further transported until its center aligns with the center of the turntable 15 as shown in FIG. 11B. At this point, the first and second positioning projections 19a and 19b of the loading arm 19 cooperate, reliably aligning the center of the optical disc with the center of the turntable 15.

More precisely, as the 12-cm disc is inserted into the optical disc apparatus 1, the first and second disc guide 23 and 25 are moved outwards. When the optical disc reaches a sufficiently deep position (FIG. 11B), a cam slider 31 is driven by a loading motor (not shown), further transporting the optical disc held between the first and second positioning projections 19a and 19b of the loading arm 19 and the disc holding pin 27a of the disc holding lever 27.

As the cam slider 31 further slides, the engagement projection CO of a connection lever 21 enters an LO cam POS (12LO). Then, the first and second positioning projections 19a and 19b of the loading arm 19 are moved, guiding the optical disc until the center of the disc aligns with the center of the turntable 15 (or the shaft of the disc motor 13). At the same time, the engagement projection HO of the disc holding lever 27 enters an HO cam POS (12LO). Then, the disc holding pin 27a moves, pushing the optical disc until the center of the disc aligns with the center of the turntable 15 (or the shaft of the disc motor 13). The optical disc is thereby set at a prescribed position on the turntable 15, where it should be clamped.

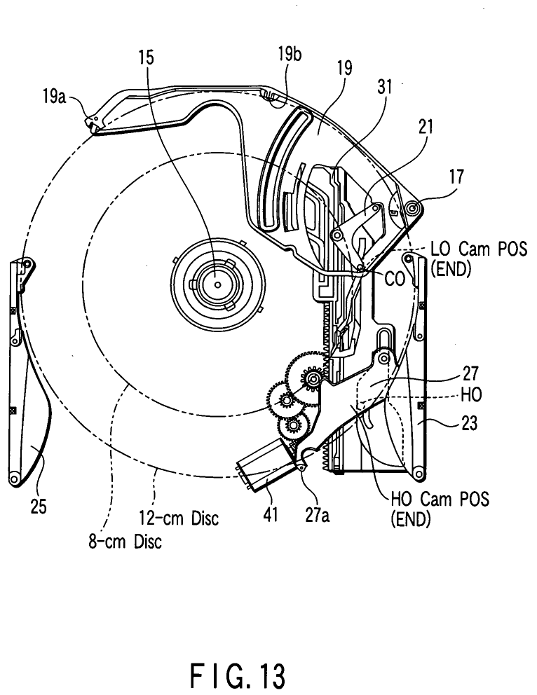

As the optical disc is inserted into the optical disc apparatus 1 as described with reference to FIGS. 6A and 6B, FIG. 7A to 7C and FIG. 8A to 8C, the turntable 15 (disc motor 13) is moved upwards from the standby position near the mechanical base chassis 11. The optical disc is thereby clamped on the turntable 15. As a result, the optical disc is set in the optical disc apparatus 1 and can be rotated, as shown in FIG. 13.

In order to rotate the optical disc, a spring-force releasing mechanism (not shown) releases the disc holding lever 27 and the loading arm 19 from the tension that biases them toward the turntable 15 as shown in FIG. 13. Thus, the disc holding lever 27 and the loading arm 19 are inhibited from contacting the outer circumference of the optical disc.

In order to eject the optical disc, the loading arm 19 is rotated in the opposite direction (to move the optical disc to the disc-ejecting position). The optical disc can therefore be ejected with ease.

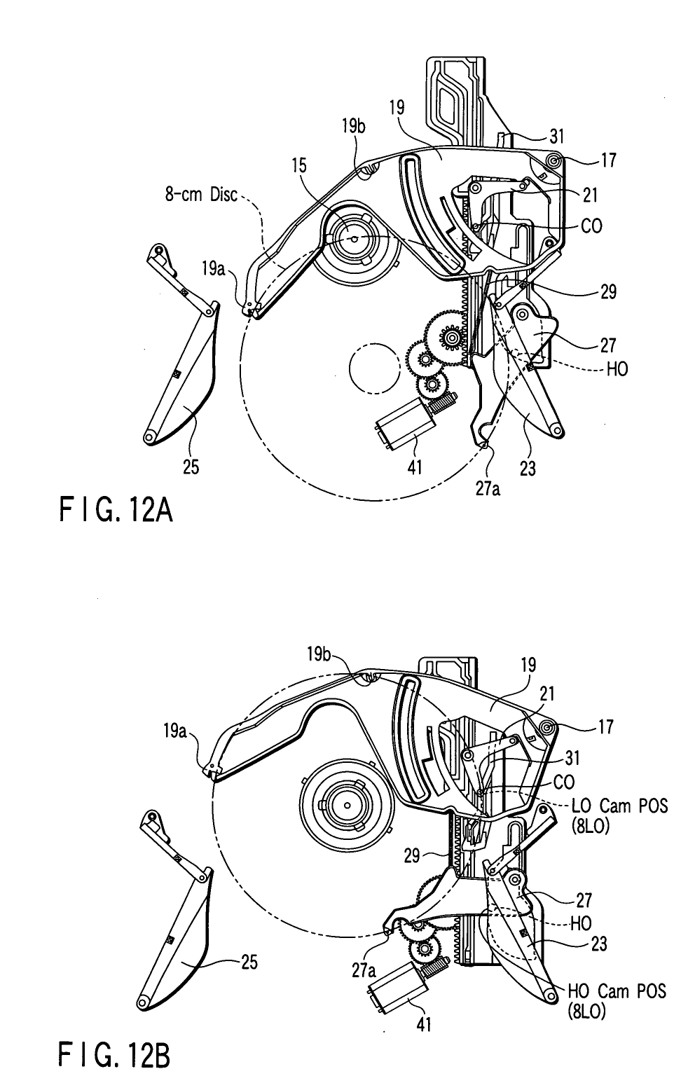

An 8-cm optical disc may be inserted (or pushed) into the optical disc apparatus 1 in the direction of arrow A. In this case, the outer circumference of the optical disc eventually contacts the disc holding pin 27a of the disc holding lever 27 as shown in FIG. 12A. The optical disc is then guided toward the loading arm 19 (and toward the turntable 15) and contacts the first positioning projection 19a of the loading arm 19. As described above, the disc holding lever 27 and the loading arm 19 are exerted with a predetermined tension and pulled toward the turntable 15. The optical disc is therefore guided to the turntable 15, while being held by the disc holding lever 27 and the loading arm 19.

As the optical disc is further pushed in this state, the loading arm 19 rotates around the fulcrum 17, moving away from the turntable 15.

At this time, the fulcrums 23a and 25b of the first and second disc guides 23 and 25, respectively, prevent the optical disc from moving in any undesirable manner. They can yet position the optical disc at substantially the center of the optical disc apparatus 1, almost at their initial positions or virtually without rotating (see FIGS. 12A and 12B), unlike in the case where a 12-cm disc is inserted into the optical disc apparatus 1. FIG. 12A shows the optical disc immediately before its center aligns with the center of the turntable 15.

As the disc holding lever 27 and the loading arm 19 are rotated, the optical disc held by the disc holding lever 27 and the loading arm 19 is further transported until its center aligns with the center of the turntable 15 as shown in FIG. 12B. At this point, the first and second positioning projections 19a and 19b of the loading arm 19 cooperate, reliably aligning the center of the 8-cm optical disc with the center of the turntable 15.

As shown in FIG. 12A, the 8-cm optical disc is guided into the optical disc apparatus 1, while contacting the first and second positioning projections 19a and 19b of the loading arm 19 and being positioned near the first and second disc guides 23 and 25 and near the fulcrums 23a and 25a thereof. As a cam slider 31 is driven by a loading motor (not shown), the optical disc is further transported into the optical disc drive 1 by the disc holding pin 27a of the disc holding lever 27.

As the cam slider 31 further slides, the engagement projection CO of the connection lever 21 enters an LO cam POS (8LO). Then, the first and second positioning projections 19a and 19b of the loading arm 19 are moved, guiding the optical disc until the center of the disc aligns with the center of the turntable 15 (or the shaft of the disc motor 13). At the same time, the engagement projection HO of the disc holding lever 27 enters the HO cam POS (8LO). Then, the disc holding pin 27a moves, pushing the optical disc until the center of the disc aligns with the center of the turntable 15 (or the shaft of the disc motor 13). The optical disc is thereby set at a prescribed position on the turntable 15, where it should be clamped. Since the disc has a diameter of 8 cm, the cam slider 31 does not move so much as in the case of inserting a 12-cm disc.

In order to rotate the 8-cm optical disc, the spring-force releasing mechanism (not shown) releases the disc holding lever 27 and the loading arm 19 from the tension that biases them toward the turntable 15. Thus, the loading arm 19 and the disc holding lever 27 are inhibited from contacting the outer circumference of the 12-cm optical disc.

As has been described, an embodiment of the present invention requires no part for coupling the mechanical base chassis to the mechanism which is provided in the main unit of the optical disc apparatus and which achieves clamping (the optical disc to the turn table) in the PUH transverse mechanisms (sub-chassis), which is indispensable in any slot-in type, optical disc apparatus. Thus, it is possible to suppress the minute vibration resulting from the interference of the mechanical components with the PUH traverse mechanism, which occurs due to background vibration or the internal vibration. This increases the vibration resistance.

The mechanical base chassis 11 cannot help but be deformed when the optical disc apparatus 1 is attached to another apparatus or receives external impacts. However, the strain-preventing slits arranged around the sub-chassis 33 minimize the deformation of the mechanical base chassis 11, because they suppress the transmission of strains generated when the apparatus is attached to the other apparatus or the transmission of impacts externally applied.

The one of the embodiment of the present invention can therefore provide a chassis structure for use in slot-in type, optical disc apparatus, which can suppresses the vibration the chassis (i.e., base) integrally formed with a part of a motor undergoes as the motor is driven, and can provide also an optical disc apparatus which has the chassis structure.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a disc motor which has a turntable and rotates a recording medium held by the turntable, at a prescribed seed in a direction parallel to a surface of the recording medium;
a main chassis which serves as a bottom surface of the disc motor and holds the disc motor;
a pickup head which is configured to read data from the recording medium rotated by the disc motor and to record data in the recording medium;
a sub-chassis which supports the pickup head, enabling the pickup head to move in a radial direction of the recording medium;
a sub-chassis holding region which is a prescribed region provided on the main chassis and arranged around the disc motor and which supports the sub-chassis; and
at least three slits which are arranged, surrounding the sub-chassis holding region, and which substantially separate the main chassis from the sub-chassis.

2. The apparatus according to claim 1, wherein the slits are defined, connecting apexes of a triangle a triangle, which lie on an outer circumference of the optical disc, respectively at a first position near the disc motor, a second position on a main sliding axis of the pickup head supported by the sub-chassis, and a third position on an auxiliary sliding axis of the pickup head.

3. The apparatus according to claim 1, wherein the slits are not parallel to one another and each have a curved part at one end at least.

4. The apparatus according to claim 3, wherein the slits are defined, connecting apexes of a triangle a triangle, which lie on an outer circumference of the optical disc, respectively at a first position near the disc motor, a second position on a main sliding axis of the pickup head supported by the sub-chassis, and a third position on an auxiliary sliding axis of the pickup head.

5. The apparatus according to claim 1, wherein the sub-chassis is made by drawing or pressing, is defined, connecting apexes of a triangle a triangle, which lie on an outer circumference of the optical disc, respectively at a first position near the disc motor, a second position on a main sliding axis of the pickup head supported by the sub-chassis, and a third position on an auxiliary sliding axis of the pickup head, and has a height different from that of the main chassis.

6. The apparatus according to claim 1, wherein the sub-chassis is made by drawing or pressing, has curved parts not parallel to one another, and has a height different from that of the main chassis.

7. The apparatus according to claim 6, wherein the sub-chassis is made by drawing or pressing, is defined, connecting apexes of a triangle a triangle, which lie on an outer circumference of the optical disc, respectively at a first position near the disc motor, a second position on a main sliding axis of the pickup head supported by the sub-chassis, and a third position on an auxiliary sliding axis of the pickup head, and has a height different from that of the main chassis.

8. A chassis structure comprising:
a main chassis which has a flat part of a prescribed size;
a motor holding part which includes a center hole defined at a prescribed position on the main chassis and which is used as a base of a motor that rotates around the axis of the center hole;
at least one slit which is made in a prescribed region of the main chassis, said region surrounding the motor holding part, and which suppresses transmission of a strain to the motor holding part, the strain having been generated when the main chassis is secured to an object; and
a supporting structure which has been made by drawing or pressing, which is provided in a space between the slit and the motor holding part, which is defined at a height different from that of the flat part of the main chassis and which supports an element that functions independently of the motor held by the motor holding part.

9. The chassis structure according to claim 8, wherein the supporting structure and the main chassis are connected by a connecting part at which the slit terminates.

10. The chassis structure according to claim 8, wherein the element that functions independently of the motor is able to move back and forth between the motor holding part and a given point on the main chassis.

11. A slot-in type optical disc apparatus comprising:
a main chassis which has a flat part of a prescribed size;
a motor holding part which includes a center hole defined at a prescribed position on the main chassis and which is used as a base of a disc motor that rotates around the axis of the center hole;
a ring member which is provided, surrounding the motor holding part, and which has an engagement member that engages with an outer circumferential surface of the disc motor held by the motor holding part used as a base, thereby to rotate the disc motor;
a plurality of engagement projections which are provided on the outer circumferential surface of the disc motor, which are spaced apart, from one another, at angular intervals of at least 90°, and which receive a thrust from the engagement member of the ring member;
a cam mechanism which linearly moves to rotate the ring member;
a pickup head which is configured to read data from the recording medium rotated by the disc motor and to record data in the recording medium;
a sub-chassis which supports the pickup head, enabling the pickup head to move in a radial direction of the recording medium;
a sub-chassis holding region which is a prescribed region provided on the main chassis and arranged around the disc motor and which supports the sub-chassis; and
at least three slits which are arranged, surrounding the sub-chassis holding region, and which substantially separate the main chassis from the sub-chassis.

12. The apparatus according to claim 11, wherein the ring member includes first and second flat parts spaced apart from each other at substantially regular angular intervals of at least 90 degrees and a sloping part connecting the first and second flat parts, the engagement member of the ring member which receive a thrust from the engagement member of the ring member exerts a rotation force, moving the disc motor between the first and second flat parts.

13. The apparatus according to claim 12, further comprising:
projecting parts which are connecting members of the ring member, which are longer than a distance between the first and second flat parts and which receive an rotation of the ring member as thrust for moving the motor between the first and second flat parts.
